(19) United States
(12) Patent Application Publication
(10) Pub. No.: US 2022/0284692 A1
(43) Pub. Date: Sep. 8, 2022

(54) METHOD FOR EXTRACTING FEATURES FROM IMAGES AND ELECTRONIC DEVICE EMPLOYING METHOD

(71) Applicant: HON HAI PRECISION INDUSTRY CO., LTD., New Taipei (TW)

(72) Inventor: CHIEN-WU YEN, New Taipei (TW)

(21) Appl. No.: 17/684,528

(22) Filed: Mar. 2, 2022

(30) Foreign Application Priority Data
Mar. 4, 2021 (CN) 202110240354.3

(51) Int. Cl. G06V 10/50

(52) U.S. Cl. CPC G06V 10/50

(57) ABSTRACT

A method for extracting an image feature includes obtaining an image, converting the image into an image matrix, dividing the image matrix to obtain an image vector, and dividing the image vector to obtain a first number of image sub blocks; obtaining and dividing a weight matrix to obtain a second number of weight vectors, dividing each weight vector to obtain a first number of weight sub blocks; obtaining and dividing an offset matrix to obtain a second number of offset quantum blocks; and performing vector multiplication on the first number of image sub blocks and the first number of weight sub blocks, adding a second number of feature sub blocks and the second number of offset quantum blocks to obtain image feature sub blocks, forming the image feature from the image feature sub blocks. An electronic device and a non-volatile storage medium performing the above-described method are also disclosed.

### FIELD

The subject matter herein generally relates to the field of image processing, in particular to a feature extracting method and an electronic device.

### BACKGROUND

Before image classification, recognition, and detection, it is usually necessary to extract features of an image. The existing feature extraction methods generally use direct multiplication of an image and weighting vector to realize feature extraction, which reduces the efficiency of feature extraction.

Therefore, there is a room for improvement.

### BRIEF DESCRIPTION OF THE DRAWINGS

Implementations of the present disclosure will now be described, by way of embodiments, with reference to the attached figures.

FIG. 1 is a flowchart of an embodiment of a method for extracting features of an image according to the present disclosure.

FIG. 2 is a block diagram of an embodiment of a device for extracting features of an image according to the present disclosure.

FIG. 3 is a block diagram of an embodiment of an electronic device according to the present disclosure.

FIG. 4 is a schematic diagram of an embodiment of a method for extracting features of an image according to the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

The method of the present disclosure is applied to one or more electronic devices. The electronic device is hardware which includes, but is not limited to, microprocessor, application specific integrated circuit (ASIC), field programmable gate array (FPGA), digital signal processor (DSP) embedded devices.

The electronic device can be a desktop computer, a notebook computer, a tablet computer, a cloud server, and other computing device. The electronic device can carry out human-computer interaction with a user through a keyboard, a mouse, a remote controller, a touch pad, or a voice control device.

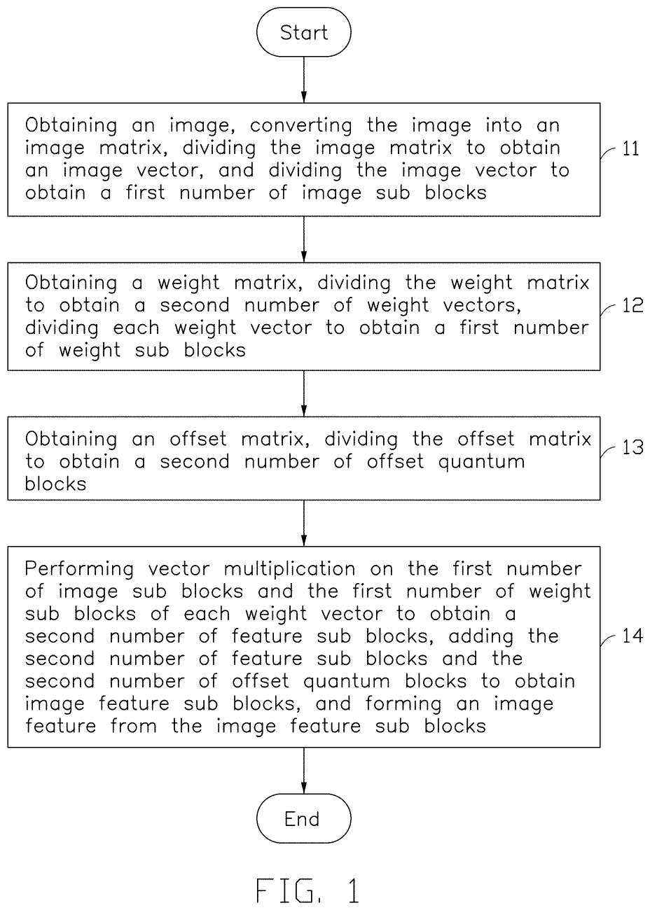

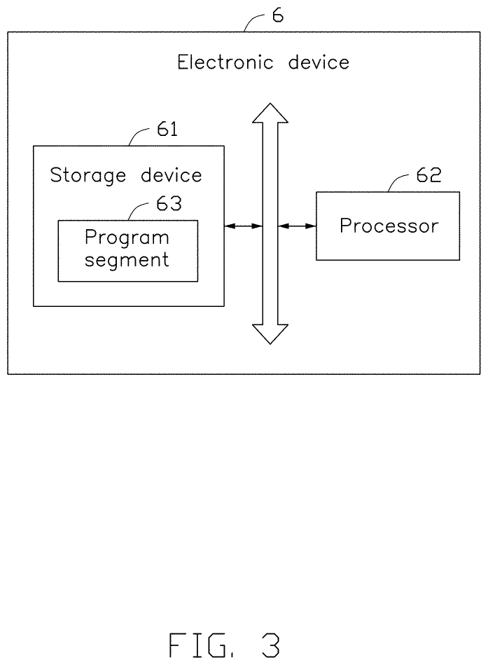

FIG. 1 illustrates a flowchart of one embodiment of a method for extracting features of an image of the present disclosure. The method for extracting features of an image can be applied to an electronic device 6 (as shown in FIG. 3).

The function for extracting provided by the method of the present disclosure can be directly integrated on the electronic device 6, or run on the electronic device 6 in the form of a software development kit (SDK).

As shown in FIG. 1, the method includes the following steps:

At block 11, obtaining an image, converting the image into an image matrix, dividing the image matrix to obtain an image vector, and dividing the image vector to obtain a first number of image sub blocks.

In one embodiment, converting the image into an image matrix, includes:

Reading the image;

Obtaining pixel points of the image;

Forming three primary color coding values of the pixel points into a pixel vector, and forming the pixel vector into the image matrix.

In one embodiment, dividing the image matrix to obtain an image vector, includes:

Dividing the image matrix into a preset number of rows to obtain a preliminary image vector set, and the preliminary image vector set includes at least one preliminary image vector;

Determining whether there is a preliminary image vector with a number of rows less than the preset number of rows in the preliminary image vector set;

when there is an image vector whose number of rows is less than the preset number of rows in the preliminary image vector set, applying a preset value to fill the preliminary image vector, to obtain the preliminary image vector whose number of rows is equal to the preset number of rows, and taking the preliminary image vector as the image vector. Or, taking the preliminary image vector as the image vector when there is no image vector which has a number of rows less than the preset number of rows in the preliminary image vector set.

In one embodiment, dividing the image vector to obtain a first number of image sub blocks, includes:

Dividing the image vector into a preset number of columns to obtain a first number of preliminary image sub blocks;

Determining whether there is a preliminary image sub block whose number of columns is less than the preset number of columns in the preliminary image sub block;

When there is a preliminary image sub block whose number of columns is less than the preset number of columns in the preliminary image sub block, applying a preset value to fill the preliminary image sub blocks to obtain the preliminary image sub blocks equal to the preset number of columns, and taking the first number of preliminary image sub blocks as the first number of image sub blocks. Or, when there is no preliminary image sub block with a number of columns less than the preset number of columns in the preliminary image sub block, taking the first number of preliminary image sub blocks as the first number of image sub blocks.

For example, the preset number of rows can be 3 rows, the preset number of columns can be 3 columns, and the preset value can be 0. When the number of rows of the image matrix is 11 rows and the number of columns is 11 columns, the image matrix is divided according to 3 rows to obtain 4 preliminary image vectors, one of which is 2 rows and 11 columns, and the preliminary image vector is filled with 0 to obtain 4 image vectors with 3 rows and 11 columns. The image vectors of 3 rows and 11 columns are divided according to 3 columns to obtain 4 preliminary image sub blocks, one of which is 3 rows and 2 columns. The preliminary image sub block is filled with the preset value 0 to obtain 4 image sub blocks of 3 rows and 3 columns.

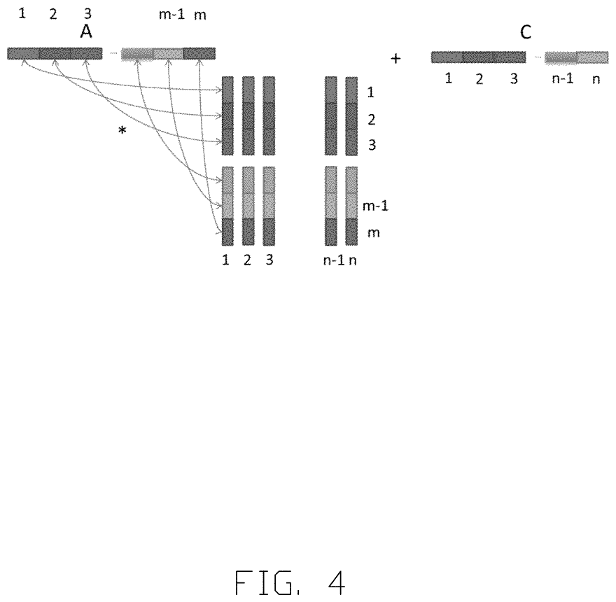

For example, referring to FIG. 4, the image vector A is divided according to the preset number of columns to obtain m preliminary image sub blocks. When the number of columns of the mth preliminary image sub block is less than the preset number of columns, the mth preliminary image sub block is filled with 0 to obtain m image sub blocks.

At block 12, obtaining a weight matrix, dividing the weight matrix to obtain a second number of weight vectors, dividing each weight vector to obtain a first number of weight sub blocks.

In the embodiment, dividing the weight matrix to obtain a second number of weight vectors includes:

Dividing the weight matrix according to the preset number of columns to obtain a second number of preliminary weight vectors;

Determining whether there is a preliminary weight vector with a number of columns which is less than the preset number of columns in the preliminary weight vectors;

When there is a weight vector whose number of columns is less than the preset number of columns in the preliminary weight vector, applying the preset value to fill the preliminary weight vector to obtain the preliminary weight vector whose number of columns is equal to the preset number of columns, taking the second number of preliminary weight vectors as the second number of the weight vectors; or when there is no weight vector whose number of columns is less than the preset number of columns in the preliminary weight vector, taking the second number of preliminary weight vectors as the second number of the weight vectors.

In the embodiment, dividing each weight vector to obtain a first number of weight sub blocks, includes:

Dividing each weight vector according to the preset number of rows to obtain a fourth number of preliminary weight sub blocks.

Determining whether the fourth number of the preliminary weight sub blocks is equal to the first number of the weight sub blocks;

When the fourth number is less than the first number, calculating a first difference between the fourth number and the first number, and increasing the number of preliminary weight sub blocks according to the first difference until the first number of preliminary weight sub blocks is obtained; or when the fourth number is greater than the first number, selecting the first number of the preliminary weight sub blocks from the fourth number of the preliminary weight sub blocks;

Determining whether there is a preliminary weight sub block with a number of columns which is less than the preset number of columns in the first number of preliminary weight sub blocks;

When there are preliminary weight sub blocks with a number of columns less than the preset number of columns in the first number of preliminary weight sub blocks, applying a preset value to fill in a preliminary weight sub block whose number of columns is less than the preset number of columns to obtain a preliminary weight sub block whose number of columns is equal to the preset number of columns, and taking the first number of preliminary weight sub blocks as the first number of weight sub blocks. Or, when there is no preliminary weight sub block with a number of columns which is less than the preset number of columns in the first number of preliminary weight sub blocks, taking the first number of preliminary weight sub blocks as the first number of weight sub blocks.

In one embodiment, the weight matrix is used to measure the importance of features in the image matrix.

In one embodiment, the weight matrix can be a matrix in a coding layer of a self-encoder or a matrix in a convolution layer of a convolution neural network. The weight matrix can be stored in an artificial intelligence chip for general matrix multiplication.

For example, when the number of rows of the weight matrix is 11 rows and the number of columns is 11 columns, the weight matrix is divided into 3 rows to obtain 4 preliminary weight vectors. One of the preliminary weight vectors is 2 rows and 11 columns, the preliminary weight vector is filled with the preset value 0 to obtain 4 weight vectors with 3 rows and 11 columns. The weight vectors of 3 rows and 11 columns are divided by 3 columns to obtain 4 preliminary weight sub blocks. One of the preliminary weight sub blocks is 3 rows and 2 columns, and the preliminary weight sub block is filled with the preset value 0 to obtain 4 weight sub blocks with 3 rows and 3 columns.

For example, referring to FIG. 4, the weight matrix B is divided according to the preset number of columns to obtain n columns of preliminary weight vector. When the number of columns of the nth column preliminary weight vector is less than the preset number of columns, 0 is used to fill the nth column preliminary weight vector to obtain the n column weight vector. Each column of the n column weight vector is divided according to the preset number of rows to obtain m preliminary weight blocks. When the number of columns of the mth preliminary weight sub block is less than the preset number of columns, the mth preliminary weight sub block is filled with 0 to obtain m weighted sub blocks.

At block 13, obtaining an offset matrix, dividing the offset matrix to obtain a second number of offset quantum blocks.

In one embodiment, dividing the offset matrix to obtain a second number of offset quantum blocks, includes:

Dividing the offset matrix according to the preset number of rows to obtain a plurality of preliminary offset vectors, and selecting an offset vector from the preliminary offset vectors;

Dividing the offset vector according to the preset number of columns to obtain a fifth number of preliminary offset quantum blocks;

Determining whether the fifth number of the preliminary offset quantum blocks is equal to the second number of the offset quantum blocks;

When the fifth number is less than the second number, calculating a second difference between the fifth number and the second number, and increasing the number of preliminary offset quantum blocks according to the second difference until a second number of preliminary offset quantum blocks is obtained. Or, when the fifth number is greater than the second number, selecting a second number of preliminary offset quantum blocks from the fifth number of preliminary offset quantum blocks;

Determining whether there is a preliminary offset quantum block in which the number of columns is less than the preset number of columns or the number of rows is less than the preset number of rows in the second number of preliminary offset quantum blocks;

When the number of columns is less than the preset number of columns or the number of rows is less than the preset number of rows in the second number of preliminary offset quantum blocks, applying the preset value to fill the preliminary offset quantum block with the number of columns which is less than the preset number of columns or the number of rows less than the preset number of rows, to obtain the preliminary offset quantum block with the number of columns equal to the preset number of columns and the number of rows equal to the preset number of rows, and taking the second number of preliminary offset quantum blocks as the second number of offset quantum blocks. Or, when there is no preliminary offset quantum block in which the number of columns is less than the preset number of columns or the number of rows is less than the preset number of rows in the second number of preliminary offset quantum blocks, taking the second number of the preliminary offset quantum blocks as the second number of offset quantum blocks.

In one embodiment, the offset matrix is used to measure the difficulty of generating positive or negative excitation by the neural network.

In one embodiment, the offset matrix can be a matrix in the coding layer of the self-encoder or a matrix in the convolution layer of the convolutional neural network. The offset matrix can be stored in an artificial intelligence chip for general matrix multiplication.

For example, when the number of rows and columns of the weight matrix is 11, the weight matrix is divided into 3 rows to obtain 4 preliminary weight vectors, and the first preliminary weight vector is selected as the weight vector. The weight vectors of 3 rows and 11 columns are divided into 3 columns to obtain 4 preliminary weight sub blocks, one of which is 3 rows and 2 columns, and the preliminary weight sub block is filled with the preset value 0 to obtain four weight sub blocks with 3 rows and 3 columns.

For example, referring to FIG. 4, the offset vector C is divided according to the preset number of columns to obtain n preliminary offset quantum blocks. When the number of columns of the nth preliminary offset quantum block is less than the preset number of columns, the nth preliminary offset quantum block is filled with 0 to obtain n offset quantum blocks.

At block 14, performing vector multiplication on the first number of image sub blocks and the first number of weight sub blocks of each weight vector to obtain a second number of feature sub blocks, adding the second number of feature sub blocks and the second number of offset quantum blocks to obtain image feature sub blocks, and forming an image feature from the image feature sub blocks.

For example, the four weight sub blocks of the weight vector and the four image sub blocks of the image vector are multiplied and summed respectively to obtain four feature sub blocks, and the four feature sub blocks and four offset quantum blocks are added to obtain four image feature sub blocks, the four image feature sub blocks form the image features.

For example, referring to FIG. 4, vector multiplication is performed on the image vector A and each column of weight vector in the weight matrix, m image sub blocks in the image vector A and m weight sub blocks in each column of weight vector are multiplied and summed in turn to obtain n feature sub blocks. The n feature sub blocks and the n offset quantum blocks are added in turn to obtain n image feature sub blocks, the n image feature sub blocks form the image features.

In one embodiment, each of the image sub block, the weight sub block, and the offset quantum block has a preset number of rows and a preset number of columns, and the preset number of columns is the same as the preset number of rows.

In one embodiment, the method for extracting image features of an image can be used for similar determinations in relation to images.

Performing similar image determination applying the method for extracting image features of an image, includes:

Obtaining a first image to be detected and a second image to be detected, and converting the first image to be detected and the second image to be detected into a first image vector to be detected and a second image vector to be detected;

Applying the image feature extracting method to calculate a first image feature to be detected of the first image vector and a second image feature to be detected of the second image vector;

Calculating an error function value between the first image feature to be detected and the second image feature to be detected applying a preset error function;

When the error function value is less than a preset threshold, determining that the first image to be detected and the second image to be detected are the same image; when the error function value is greater than the preset threshold, determining that the first image to be detected and the second image to be detected are different images.

In one embodiment, the image feature extracting method can also be used for self-encoding.

The image feature extracting method can be used for the encoding layer and/or decoding layer of a self-encoder. Reconstructing an image by the encoder includes:

Obtaining an image to be reconstructed and converting the image to be reconstructed into an image vector;

Inputting the image vector to be reconstructed into the coding layer of the self-encoder; the coding layer of the self-encoder uses the image feature extracting method to obtain a hidden vector of the reconstructed image;

Inputting the hidden vector into the decoding layer of the self-encoder; the decoding layer of the self-encoder uses the image feature extracting method to obtain the reconstructed image.

The embodiment of the present disclosure can divide the image matrix, the weight matrix, and a deviation matrix into sub blocks for operation, which reduces the amount of convolution operations in the neural network in the process of image feature extraction, so as to improve the efficiency of feature extraction in the image.

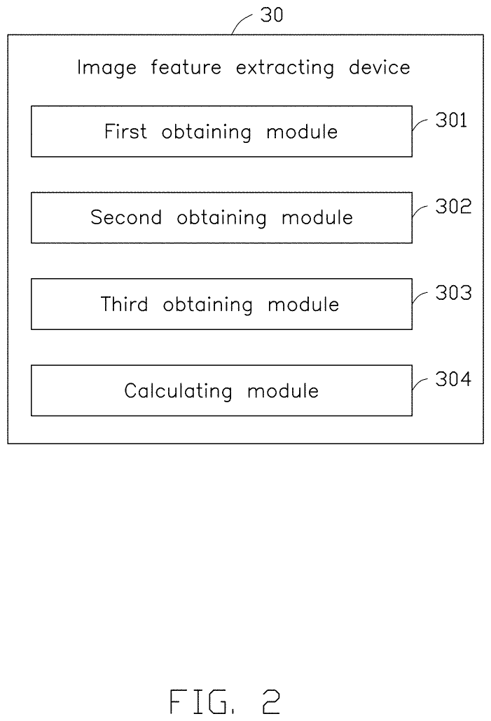

FIG. 2 illustrates a block diagram of one embodiment of an image feature extracting device 30 according to the present disclosure.

In some embodiments, the image feature extracting device 30 operates in an electronic device. The image feature extracting device 30 may include a plurality of functional modules composed of program code segments. The program code of each program segment in the image feature extracting device 30 can be stored in a storage device and executed by at least one processor.

In the embodiment, the image feature extracting device 30 can be divided into a plurality of functional modules according to the functions performed. As shown in FIG. 2, the image feature extracting device 30 includes a first obtaining module 301, a second obtaining module 302, a third obtaining module 303, and a calculating module 304. The modules in the present disclosure refer to a series of computer program segments that can be executed by at least one processor and can complete fixed functions, which are stored in the storage device.

The first obtaining module 301 obtains an image, converts the image into an image matrix, divides the image matrix to obtain an image vector, and divides the image vector to obtain a first number of image sub blocks.

In the embodiment, the first obtaining module 301 reads the image, obtains pixel points of the image, and forms three primary color values of the pixel points into a pixel vector, and forms the pixel vector in the image matrix.

In the embodiment, the first obtaining module 301 divides the image matrix according to a preset number of rows to obtain a preliminary image vector set, and the preliminary image vector set includes at least one preliminary image vector. The first obtaining module 301 determines whether there is a preliminary image vector with a number of rows which is less than the preset number of rows in the preliminary image vector set. When there is an image vector whose number of rows is less than the preset number of rows in the preliminary image vector set, the first obtaining module 301 uses a preset value to fill such preliminary image vector to obtain the preliminary image vector whose number of rows is equal to the preset number of rows, and takes the preliminary image vector as the image vector. Or, the first obtaining module 301 takes the preliminary image vector as the image vector when there is no image vector with a lesser number of rows than the preset number of rows in the preliminary image vector set.

In the embodiment, the first obtaining module 301 divides the image vector according to a preset number of columns to obtain a first number of preliminary image sub blocks. The first obtaining module 301 determines whether there is a preliminary image sub block in which the number of columns is less than the preset number of columns in the preliminary image sub block. When there is a preliminary image sub block in which the number of columns is less than the preset number of columns in the preliminary image sub block, the first obtaining module 301 uses a preset value to fill the preliminary image sub blocks to obtain the preliminary image sub blocks whose number of columns is equal to the preset number of columns, and takes the first number of preliminary image sub blocks as the first number of image sub blocks. Or, when there is no preliminary image sub block with a number of columns less than the preset number of columns in the preliminary image sub block, the first obtaining module 301 takes the first number of preliminary image sub blocks as the first number of image sub blocks.

In the embodiment, the second obtaining module 302 obtains a weight matrix, divides the weight matrix to obtain a second number of weight vectors, and divides each weight vector to obtain a first number of weight sub blocks.

In the embodiment, the second obtaining module 302 divides the weight matrix according to the preset number of columns to obtain a second number of preliminary weight vectors. The second obtaining module 302 determines whether there is a preliminary weight vector with a number of columns which is less than the preset number of columns in the preliminary weight vectors. When there is a weight vector whose number of columns is less than the preset number of columns in the preliminary weight vector, the second obtaining module 302 uses the preset value to fill the preliminary weight vector to obtain the preliminary weight vector whose number of columns is equal to the preset number of columns, and takes the second number of preliminary weight vectors as the second number of weight vectors. The second obtaining module 302 divides each weight vector according to the preset number of rows to obtain a fourth number of preliminary weight sub blocks.

The second obtaining module 302 determines whether the fourth number of the preliminary weight sub blocks is equal to the first number of the preliminary weight sub blocks. When the fourth number is less than the first number, the second obtaining module 302 calculates a first difference between the fourth number and the first number, and increases the number of preliminary weight sub blocks according to the first difference until the first number of preliminary weight sub blocks is obtained. Or, when the fourth number is greater than the first number, the second obtaining module 302 selects the first number of preliminary weight sub blocks from the fourth number of preliminary weight sub blocks.

The second obtaining module 302 determines whether there is a preliminary weight sub block with a number of columns which is less than the preset number of columns in the first number of preliminary weight sub blocks. When there are preliminary weight sub blocks with a number of columns less than the preset number of columns in the first number of preliminary weight sub blocks, the second obtaining module 302 uses a preset value to fill in a preliminary weight sub block to obtain a preliminary weight sub block whose number of columns is equal to the preset number of columns, and takes the first number of preliminary weight sub blocks as the first number of weight sub blocks. Or, when there is no preliminary weight sub block with a number of columns which is less than the preset number of columns in the first number of preliminary weight sub blocks, the second obtaining module 302 takes the first number of preliminary weight sub blocks as the first number of weight sub blocks.

In one embodiment, the weight matrix is used to measure the importance of features in the image matrix.

In one embodiment, the weight matrix can be a matrix in the coding layer of the self-encoder or a matrix in the convolution layer of the convolution neural network. The weight matrix can be stored in an artificial intelligence chip for general matrix multiplication.

The third obtaining module 303 obtains an offset matrix, and divides the offset matrix to obtain a second number of offset quantum blocks.

The third obtaining module 303 divides the offset matrix according to the preset number of rows to obtain a plurality of preliminary offset vectors, and selects an offset vector from the preliminary offset vectors.

The third obtaining module 303 divides the offset vector according to the preset number of columns to obtain a fifth number of preliminary offset quantum blocks, and determines whether the fifth number of the preliminary offset quantum blocks is equal to the second number of the preliminary offset quantum blocks. When the fifth number is less than the second number, the third obtaining module 303 calculates a second difference between the fifth number and the second number, and increases the number of preliminary offset quantum blocks according to the second difference until a second number of preliminary offset quantum blocks is obtained. Or, when the fifth number is greater than the second number, the third obtaining module 303 selects a second number of preliminary offset quantum blocks from the fifth number of preliminary offset quantum blocks.

The third obtaining module 303 determines whether there is a preliminary offset quantum block in which the number of columns is less than the preset number of columns or the number of rows is less than the preset number of rows in the second number of preliminary offset quantum blocks. When the number of columns is less than the preset number of columns or the number of rows is less than the preset number of rows in the second number of preliminary offset quantum blocks, the third obtaining module 303 uses the preset value to fill the preliminary offset quantum block to obtain the preliminary offset quantum block with the number of columns equal to the preset number of columns and the number of rows equal to the preset number of rows, and takes the second number of preliminary offset quantum blocks as the second number of offset quantum blocks. Or, when there is no preliminary offset quantum block in which the number of columns is less than the preset number of columns or the number of rows is less than the preset number of rows in the second number of preliminary offset quantum blocks, the third obtaining module 303 takes the second number of preliminary offset quantum blocks as the second number of offset quantum blocks.

In one embodiment, the offset matrix is used to measure the difficulty of generating positive or negative excitation by the neural network.

In one embodiment, the offset matrix can be a matrix in the coding layer of the self-encoder or a matrix in the convolution layer of the convolutional neural network. The offset matrix can be stored in an artificial intelligence chip for general matrix multiplication.

The calculating module 304 performs vector multiplication on the first number of image sub blocks and the first number of weight sub blocks of each weight vector to obtain a second number of feature sub blocks, and adds the second number of feature sub blocks and the second number of offset quantum blocks to obtain image feature sub blocks, the image feature sub block form the image feature.

In one embodiment, each of the image sub block, the weight sub block, and the offset quantum block has a preset number of rows and a preset number of columns, and the preset number of columns is the same as the preset number of rows.

The embodiment of the present disclosure can divide the image matrix, the weight matrix, and a deviation matrix into sub blocks for operations, which reduces the amount of convolution operations in the neural network in the process of image feature extraction, so as to improve the efficiency of feature extraction of the image.

FIG. 3 illustrate the electronic device 6 in accordance with an embodiment of the present disclosure.

The electronic device 6 can further include, but is not limited to, a storage device 61, at least one processor 62, and a program segment 63 stored in the storage device 61. The processor 62 may execute the program code of the program segment 63 to implement blocks 11-14 in the method shown in FIG. 1. The processor 62 may execute the program code of the program segment 63 to implement the functions of the image feature extracting device 30 shown in FIG. 2.

The modules 301-304 include computer instructions or codes in form of one or more programs that may be stored in the storage device 61, and which are executed by the at least one processor 62. In other embodiment, the modules 301-304 may also be a program instruction or firmware that is embedded in the processor 62.

The one or more modules may be a series of computer program instruction segments capable of completing specific functions, and the instruction segments are used to describe the execution process of the program segment 63 in the electronic device 6.

The block diagram merely shows an example of the electronic device 6 and does not constitute a limitation to the electronic device 6. In other examples, more or less components than those illustrated may be included, or some components may be combined, or different components used. For example, the electronic device 6 may also include input and output devices, network access devices, a bus, and the like.

The processor 62 may be a central processing unit (CPU), or may be other general purpose processor, a digital signal processor (DSP), an application specific integrated circuit (ASIC), a Field-Programmable gate array (FPGA) or other programmable logic device, a transistor logic device, or a discrete hardware component. The general purpose processor may be a microprocessor. The processor 62 may also be any conventional processor. The processor 62 is a control center of the electronic device 6. The processor 62 connects the parts of the electronic device 6 applying various interfaces and lines.

The storage device 61 can be used to store the program segment 63. The processor 62 operates or executes the program segment stored in the storage device 61 and recalls data stored in the storage device 61, and implements various functions of the electronic device 6. The storage device 61 mainly includes a storage program area and a storage data area, the storage program area may store an operating system, and an application (such as sound playback and image playback) required for at least one function. The storage data area may store data which is created.

The storage device 61 may include a RAM, and may also include non-volatile memory such as a hard disk, a memory, a plug-in hard disk, a smart memory card (SMC), and a Secure Digital (SD) card, a flash card, at least one disk storage device, flash device, or other volatile or non-volatile solid-state storage device.

The modules and units which are integrated in the electronic device 6, if implemented in the form of software functional units and sold or used as separate products, may be stored in a computer readable storage medium. Based on such understanding, the present disclosure implements all or part of the processes in the foregoing embodiments, and the purposes of the disclosure may also be implemented and achieved by a computer program instructing related hardware. The computer program may be stored in a computer readable storage medium. The steps of the various method embodiments described above may be implemented by a computer program when executed by a processor. The computer program includes a computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), a random access memory (RAM), electrical carrier signals, telecommunications signals, and software distribution media. It should be noted that the content contained in the computer readable medium can be appropriately increased or decreased according to the requirements of legislation and patent practice in jurisdictions. For example, in some jurisdictions, according to legislation and patent practice, the computer readable medium does not include electric carrier signals and telecommunication signals.

In several embodiments provided by the present disclosure, it should be understood that the disclosed electronic devices and methods can be realized in other ways. For example, the electronic device described above is only schematic. For example, the division of the module is only a division according to logical function, and there may be another division mode in actual implementation.

Each functional module in each embodiment of the present disclosure can be integrated in the same processing module, each module can exist separately, or two or more modules can be integrated in the same module. The above integrated modules can be realized in the form of hardware or hardware plus software function modules.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A method for extracting an image feature comprising:
obtaining an image, converting the image into an image matrix, dividing the image matrix to obtain an image vector, and dividing the image vector to obtain a first number of image sub blocks;
obtaining a weight matrix, dividing the weight matrix to obtain a second number of weight vectors, dividing each of the weight vectors to obtain a first number of weight sub blocks;
obtaining an offset matrix, dividing the offset matrix to obtain a second number of offset quantum blocks; and
performing vector multiplication on the first number of image sub blocks and the first number of weight sub blocks of each of the weight vectors, to obtain a second number of feature sub blocks, adding the second number of feature sub blocks and the second number of offset quantum blocks to obtain image feature sub blocks, and forming the image feature from the image feature sub blocks.

2. The method according to claim 1, wherein each of the image sub block, the weight sub block, and the offset quantum block has a preset number of rows and a preset number of columns, and the preset number of columns is the same as the preset number of rows.

3. The method according to claim 2, further comprising:
dividing the image matrix according to the preset number of rows to obtain a preliminary image vector set, the preliminary image vector set comprising at least one preliminary image vector;
determining whether there is a preliminary image vector with a number of rows less than the preset number of rows in the preliminary image vector set;
applying a preset value to fill the preliminary image vector whose number of rows is less than the preset number of rows, to obtain the preliminary image vector whose number of rows is equal to the preset number of rows, and taking the preliminary image vector whose number of rows is equal to the preset number of rows as the image vector when there is an image vector whose number of rows is less than the preset number of rows in the preliminary image vector set; or taking the preliminary image vector as the image vector when there is no image vector whose number of rows is less than the preset number of rows in the preliminary image vector set.

4. The method according to claim 2, further comprising:
dividing the image vector according to the preset number of columns to obtain a first number of preliminary image sub blocks;
determining whether there is a preliminary image sub block in which a number of columns is less than the preset number of columns in the preliminary image sub block;
applying a preset value to fill the preliminary image sub blocks whose number of columns is less than the preset number of columns to obtain the preliminary image sub blocks whose number of columns is equal to the preset number of columns, and taking the first number of preliminary image sub blocks as the first number of image sub blocks when there is a preliminary image sub block in which a number of columns is less than the preset number of columns in the preliminary image sub block; or taking the first number of preliminary image sub blocks as the first number of image sub blocks when there is no preliminary image sub block with a number of columns less than the preset number of columns in the preliminary image sub block.

5. The method according to claim 2, further comprising:
dividing the weight matrix according to the number of columns to obtain a second number of preliminary weight vectors;
determining whether there is a preliminary weight vector with a number of columns less than the preset number of columns in the preliminary weight vectors;
applying a preset value to fill the preliminary weight vector whose number of columns is less than the preset number of columns, to obtain the preliminary weight vector whose number of columns is equal to the preset number of columns, taking the second number of preliminary weight vectors as the second number of weight vectors when there is a weight vector whose number of columns is less than the preset number of columns in the preliminary weight vectors; or taking the second number of preliminary weight vectors as the second number of weight vectors when there is no weight vector whose number of columns is less than the preset number of columns in the preliminary weight vectors.

6. The method according to claim 2, further comprising:
dividing each of the weight vectors according to the preset number of rows to obtain a fourth number of preliminary weight sub blocks;
determining whether the fourth number of the preliminary weight sub blocks is equal to the first number of the preliminary weight sub blocks;
calculating a first difference between the fourth number of the preliminary weight sub blocks and the first number of the preliminary weight sub blocks, and increasing a number of preliminary weight sub blocks according to the first difference until a first number of preliminary weight sub blocks is obtained when the fourth number is less than the first number; or selecting the first number of preliminary weight sub blocks from the fourth number of preliminary weight sub blocks when the fourth number is greater than the first number;
determining whether there is a preliminary weight sub block with a number of columns less than the preset number of columns in the first number of preliminary weight sub blocks;
applying a preset value to fill in a preliminary weight sub block whose number of columns is less than the preset number of columns to obtain a preliminary weight sub block whose number of columns is equal to the preset number of columns, taking the first number of preliminary weight sub blocks as the first number of weight sub blocks when there are preliminary weight sub blocks with a number of columns less than the preset number of columns in the first number of preliminary weight sub blocks; or taking the first number of preliminary weight sub blocks as the first number of weight sub blocks when there is no preliminary weight sub block with a number of columns less than the preset number of columns in the first number of preliminary weight sub blocks.

7. The method according to claim 2, further comprising:
dividing the offset matrix according to the preset number of rows to obtain a plurality of preliminary offset vectors, and selecting an offset vector from the preliminary offset vectors;
dividing the offset vector according to the preset number of columns to obtain a fifth number of preliminary offset quantum blocks;
determining whether the fifth number of the preliminary offset quantum blocks is equal to the second number of the preliminary offset quantum blocks;
calculating a second difference between the fifth number of the preliminary offset quantum blocks and the second number of the preliminary offset quantum blocks, and increasing a number of preliminary offset quantum blocks according to the second difference until a second number of preliminary offset quantum blocks is obtained when the fifth number is less than the second number; or selecting the second number of preliminary offset quantum blocks from the fifth number of preliminary offset quantum blocks when the fifth number is greater than the second number;
determining whether there is a preliminary offset quantum block in which a number of columns is less than the preset number of columns or a number of rows is less than the preset number of rows in the second number of preliminary offset quantum blocks;
applying a preset value to fill the preliminary offset quantum block with the number of columns less than the preset number of columns or the number of rows less than the preset number of rows, to obtain the preliminary offset quantum block with the number of columns equal to the preset number of columns and the number of rows equal to the preset number of rows, taking the second number of preliminary offset quantum blocks as the second number of offset quantum blocks when the number of columns is less than the preset number of columns or the number of rows is less than the preset number of rows in the second number of preliminary offset quantum blocks; or taking the second number of preliminary offset quantum blocks as the second number of offset quantum blocks when there is no preliminary offset quantum block in which a number of columns is less than the preset number of columns or a number of rows is less than the preset number of rows in the second number of preliminary offset quantum blocks.

8. An electronic device, comprising:
a storage device; and
at least one processor, wherein the storage device stores one or more programs, when executed by the at least one processor, the one or more programs cause the at least one processor to:
obtain an image, convert the image into an image matrix, divide the image matrix to obtain an image vector, and divide the image vector to obtain a first number of image sub blocks;
obtain a weight matrix, divide the weight matrix to obtain a second number of weight vectors, divide each of the weight vectors to obtain a first number of weight sub blocks;
obtain an offset matrix, divide the offset matrix to obtain a second number of offset quantum blocks; and
perform vector multiplication on the first number of image sub blocks and the first number of weight sub blocks of each of the weight vectors, to obtain a second number of feature sub blocks, add the second number of feature sub blocks and the second number of offset quantum blocks to obtain image feature sub blocks, and form an image feature from the image feature sub blocks.

9. The electronic device according to claim 8, wherein each of the image sub block, the weight sub block, and the offset quantum block has a preset number of rows and a preset number of columns, and the preset number of columns is the same as the preset number of rows.

10. The electronic device according to claim 9, wherein the at least one processor is further caused to:
divide the image matrix according to the preset number of rows to obtain a preliminary image vector set, the preliminary image vector set comprising at least one preliminary image vector;
determine whether there is a preliminary image vector with a number of rows less than the preset number of rows in the preliminary image vector set;
apply the preset value to fill the preliminary image vector whose number of rows is less than the preset number of rows, to obtain the preliminary image vector whose number of rows is equal to the preset number of rows, and take the preliminary image vector whose number of rows is equal to the preset number of rows as the image vector when there is an image vector whose number of rows is less than the preset number of rows in the preliminary image vector set; or take the preliminary image vector as the image vector when there is no image vector whose number of rows is less than the preset number of rows in the preliminary image vector set.

11. The electronic device according to claim 9, wherein the at least one processor is further caused to:
divide the image vector according to the preset number of columns to obtain a first number of preliminary image sub blocks;
determine whether there is a preliminary image sub block in which a number of columns is less than the preset number of columns in the preliminary image sub block;
apply a preset value to fill the preliminary image sub blocks whose number of columns is less than the preset number of columns to obtain the preliminary image sub blocks whose number of columns is equal to the preset number of columns, and take the first number of preliminary image sub blocks as the first number of image sub blocks when there is a preliminary image sub block in which a number of columns is less than the preset number of columns in the preliminary image sub block; or take the first number of preliminary image sub blocks as the first number of image sub blocks when there is no preliminary image sub block with a number of columns less than the preset number of columns in the preliminary image sub block.

12. The electronic device according to claim 9, wherein the at least one processor is further caused to:
divide the weight matrix according to the number of columns to obtain a second number of preliminary weight vectors;
determine whether there is a preliminary weight vector with a number of columns less than the preset number of columns in the preliminary weight vectors;
apply the preset value to fill the preliminary weight vector whose number of columns is less than the preset number of columns, to obtain the preliminary weight vector whose number of columns is equal to the preset number of columns, take the second number of preliminary weight vectors as the second number of weight vectors when there is a weight vector whose number of columns is less than the preset number of columns in the preliminary weight vector; or take the second number of preliminary weight vectors as the second number of weight vectors when there is no weight vector whose number of columns is less than the preset number of columns in the preliminary weight vectors.

13. The electronic device according to claim 9, wherein the at least one processor is further caused to:
divide each of the weight vector according to the preset number of rows to obtain a fourth number of preliminary weight sub blocks;
determine whether the fourth number of the preliminary weight sub blocks is equal to the first number of the preliminary weight sub blocks;
calculate a first difference between the fourth number of the preliminary weight sub blocks and the first number of the preliminary weight sub blocks, and increases a number of preliminary weight sub blocks according to the first difference until a first number of preliminary weight sub blocks is obtained when the fourth number is less than the first number; or select the first number of the preliminary weight sub blocks from the fourth number of the preliminary weight sub blocks when the fourth number is greater than the first number;
determine whether there is a preliminary weight sub block with a number of columns less than the preset number of columns in the first number of preliminary weight sub blocks;
use a preset value to fill in a preliminary weight sub block whose number of columns is less than the preset number of columns to obtain a preliminary weight sub block whose number of columns is equal to the preset number of columns, take the first number of preliminary weight sub blocks as the first number of weight sub blocks when there are preliminary weight sub blocks with a number of columns less than the preset number of columns in the first number of preliminary weight sub blocks; or take the first number of preliminary weight sub blocks as the first number of weight sub blocks when there is no preliminary weight sub block with a number of columns less than the preset number of columns in the first number of preliminary weight sub blocks.

14. The electronic device according to claim 9, wherein the at least one processor is further caused to:
divide the offset matrix according to the preset number of rows to obtain a plurality of preliminary offset vector, and selecting an offset vector from the preliminary offset vectors;
divide the offset vector according to the preset number of columns to obtain a fifth number of preliminary offset quantum blocks;
determine whether the fifth number of the preliminary offset quantum blocks is equal to the second number of the preliminary offset quantum blocks;
calculate a second difference between the fifth number of the preliminary offset quantum blocks and the second number of the preliminary offset quantum blocks, and increases a number of preliminary offset quantum blocks according to the second difference until a second number of preliminary offset quantum blocks is obtained when the fifth number is less than the second number; or select the second number of preliminary offset quantum blocks from the fifth number of preliminary offset quantum blocks when the fifth number is greater than the second number;
determine whether there is a preliminary offset quantum block in which a number of columns is less than the preset number of columns or a number of rows is less than the preset number of rows in the second number of preliminary offset quantum blocks;
apply the preset value to fill the preliminary offset quantum block with the number of columns less than the preset number of columns or the number of rows less than the preset number of rows, to obtain the preliminary offset quantum block with the number of columns equal to the preset number of columns and the number of rows equal to the preset number of rows, take the second number of preliminary offset quantum blocks as the second number of offset quantum blocks when the number of columns is less than the preset number of columns or the number of rows is less than the preset number of rows in the second number of preliminary offset quantum blocks; or take the second number of preliminary offset quantum blocks as the second number of offset quantum blocks when there is no preliminary offset quantum block in which a number of columns is less than the preset number of columns or a number of rows is less than the preset number of rows in the second number of preliminary offset quantum blocks.

15. A non-transitory storage medium having stored thereon instructions that, when executed by a processor of a computer device installed in an electronic device, cause the processor to perform an extracting method, wherein the method comprises:
obtaining an image, converting the image into an image matrix, dividing the image matrix to obtain an image vector, and dividing the image vector to obtain a first number of image sub blocks;
obtaining a weight matrix, dividing the weight matrix to obtain a second number of weight vectors, dividing each of the weight vector to obtain a first number of weight sub blocks;
obtaining an offset matrix, dividing the offset matrix to obtain a second number of offset quantum blocks; and
performing vector multiplication on the first number of image sub blocks and the first number of weight sub blocks of each of the weight vectors, to obtain a second number of feature sub blocks, adding the second number of feature sub blocks and the second number of offset quantum blocks to obtain image feature sub blocks, and forming the image feature from the image feature sub blocks.

16. The non-transitory storage medium according to claim 15, wherein each of the image sub block, the weight sub block and the offset quantum block has a preset number of rows and a preset number of columns, and the preset number of columns is the same as the preset number of rows.

17. The non-transitory storage medium according to claim 16, further comprising:
dividing the image matrix according to the preset number of rows to obtain a preliminary image vector set, the preliminary image vector set comprising at least one preliminary image vector;
determining whether there is a preliminary image vector with a number of rows less than the preset number of rows in the preliminary image vector set;
applying a preset value to fill the preliminary image vector whose number of rows is less than the preset number of rows, to obtain the preliminary image vector whose number of rows is equal to the preset number of rows, and taking the preliminary image vector whose number of rows is equal to the preset number of rows as the image vector when there is an image vector whose number of rows is less than the preset number of rows in the preliminary image vector set; or taking the preliminary image vector as the image vector when there is no image vector whose number of rows is less than the preset number of rows in the preliminary image vector set.

18. The non-transitory storage medium according to claim 16, further comprising:
dividing the image vector according to the preset number of columns to obtain a first number of preliminary image sub blocks;
determining whether there is a preliminary image sub block in which a number of columns is less than the preset number of columns in the preliminary image sub block;
applying a preset value to fill the preliminary image sub blocks whose number of columns is less than the preset number of columns to obtain the preliminary image sub blocks whose number of columns is equal to the preset number of columns, and taking the first number of preliminary image sub blocks as the first number of image sub blocks when there is a preliminary image sub block in which a number of columns is less than the preset number of columns in the preliminary image sub block; or taking the first number of preliminary image sub blocks as the first number of image sub blocks when there is no preliminary image sub block with a number of columns less than the preset number of columns in the preliminary image sub block.

19. The non-transitory storage medium according to claim 16, further comprising:
dividing the weight matrix according to the number of columns to obtain a second number of preliminary weight vectors;
determining whether there is a preliminary weight vector with a number of columns less than the preset number of columns in the preliminary weight vectors;
applying a preset value to fill the preliminary weight vector whose number of columns is less than the preset number of columns, to obtain the preliminary weight vector whose number of columns is equal to the preset number of columns, taking the second number of preliminary weight vectors as the second number of weight vectors when there is a weight vector whose number of columns is less than the preset number of columns in the preliminary weight vectors; or taking the second number of preliminary weight vectors as the second number of weight vectors when there is no weight vector whose number of columns is less than the preset number of columns in the preliminary weight vectors.

20. The non-transitory storage medium according to claim 16, further comprising:
dividing each of the weight vectors according to the preset number of rows to obtain a fourth number of preliminary weight sub blocks;
determining whether the fourth number of the preliminary weight sub blocks is equal to the first number of the preliminary weight sub blocks;
calculating a first difference between the fourth number of the preliminary weight sub blocks and the first number of the preliminary weight sub blocks, and increasing a number of preliminary weight sub blocks according to the first difference until a first number of preliminary weight sub blocks is obtained when the fourth number is less than the first number; or selecting the first number of preliminary weight sub blocks from the fourth number of preliminary weight sub blocks when the fourth number is greater than the first number;
determining whether there is a preliminary weight sub block with a number of columns less than the preset number of columns in the first number of preliminary weight sub blocks;
applying a preset value to fill in a preliminary weight sub block whose number of columns is less than the preset number of columns to obtain a preliminary weight sub block whose number of columns is equal to the preset number of columns, taking the first number of preliminary weight sub blocks as the first number of weight sub blocks when there are preliminary weight sub blocks with a number of columns less than the preset number of columns in the first number of preliminary weight sub blocks; or taking the first number of preliminary weight sub blocks as the first number of weight sub blocks when there is no preliminary weight sub block with a number of columns less than the preset number of columns in the first number of preliminary weight sub blocks.
